(19) United States
(12) Patent Application Publication
(10) Pub. No.: US 2005/0183255 A1
(43) Pub. Date: Aug. 25, 2005

(54) PVC pipe assembly tool

(76) Inventor: Robert Duensing, Electra, TX (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/783,707

(22) Filed: Feb. 20, 2004

(51) Int. Cl. B25B 27/14

(52) U.S. Cl. 29/272

(57) ABSTRACT

A system for joining two pipes comprising: a first horseshoe-shaped member which secures to the bell-end of a first PVC pipe, said horseshoe-shaped member having a plurality of chains extending therefrom; a second member comprising a bull-plate which secures to the open end of a second PVC pipe connected to the first pipe, said bull-end plate having two chains extending therefrom, a lever mechanism configured to join the two ends together such that the lever affixes to each of the chains such that the chain of the horseshoe-shaped member is attached to a first end and the second bull-plate chain is attached to the second end on opposite sides of the fulcrum of the lever, such that once said lever is thrust in a first direction, the chains tighten and the pipes are trussed tightly together.

### FIELD OF THE INVENTION

The present invention is directed to a PVC Pipe Assembly tool. In particular, the invention is directed to a tool and device for rapidly connecting PVC pipe.

### BACKGROUND OF THE INVENTION

In the laying of large or small diameter pipe of the type, for example, used in municipal water systems, it is necessary to align and guide a pipe and into coupled engagement with the end of a previously laid pipe. Conventionally, a pair of pipes have been connected manually through a coupling pipe by means of a mold and the like. This has often required substantial human intervention, thus taking time and increasing cost. This is particularly problematic in the connection of long pipes, in particular the long pipes having large diameters which are apt to be more easily broken, particularly when the pipe is constructed from a PVC or other polymer.

A number of prior art patents have been directed toward resolving the problem of joining pipes. U.S. Pat. No. 4,836,595 to DeCarlo is directed to an apparatus for handling a pipe laid in a trench and including an elongate handle equipped with an inverted u-shaped member for guiding a pipe end into inserted engagement with an adjacent pipe end. The handle and u-shaped member are joined by a coupling. The apparatus includes a handle-equipped plate member for temporarily closing a pipe during the positioning of the same into place.

U.S. Pat. No. 4,598,452 is directed to a tool for connecting a pair of pipes through a coupling pipe which includes a handle connected to a curved member and a semi-circular plate connected from the curved member. The curved member has a supporting point at the ends of its bending portion and a point of application at the top of its projecting portion. The semi-circular plate is connected rotatably with the supporting point through a pair of links and fixed close to an edge of a coupling pipe, so as to settle the tool.

The crescent-shaped plate is connected rotatably at its neck portion with the point of application of the curved member through a pair or link. A pair of upper and lower portions of the crescent-shaped plate are adapted to engage with the pipe to be connected with offsetting the axial direction of the pipe.

U.S. Pat. No. 4,555,841 discloses a tool for aligning pipes to be secured in an end-to-end relationship which includes a strap to be secured around the end of one pipe and the lever engaging the strap. The lever has a foot to engage and to form a portion of the other pipe.

U.S. Pat. No. 6,491,476 discloses an apparatus and method for trenchless laying of pipe work. The invention incorporates a gauge for the continuous widening for a preferably wound pre-formed pipe on the linkage.

Additionally patents similarly disclose complex jaws or other mechanical means for joining two underground pipes. U.S. Pat. Nos. 3,300,205; 3,619,891; and 4,016,637 exemplify this prior art.

Each of the aforesaid systems have unique disadvantages. For example, some of the prior art exemplify systems which place undue stresses on the pipe, thus leading to possible deformation or rupture. This is particularly risky with PVC piping. Other prior art require the use of intermediate or coupling members which are not adaptable to all forms of pipes, particularly pipes which have a bell end.

It would be desirable to provide a pipe joining system which utilizes a chain driving connection system and which does not place undue stress upon piping.

It is a goal and principle objective of the present invention to provide a mechanical system which can be utilized to join large municipal PVC piping, having a bell-end in rapid and easy connection.

These and other objects of the present invention will become clear and apparent from the detailed description which follows.

### BRIEF DESCRIPTION OF THE FIGURES

FIG. 1 illustrates the first bell-end u-shaped connection of the present invention.

FIG. 1a is a sectional view of the bell-end u-shaped connection.

FIGS. 2a and 2b illustrates the bull plate embodiments for attachment of the open end of the second pipe to be connected.

FIGS. 3 and 4 illustrate the connection mechanism of the present invention in operation.

### SUMMARY OF THE INVENTION

In accordance with the present invention, a system for joining two pipe sections together is disclosed. The invention comprises a first horseshoe-shaped member which fits around and is secured by the bell-end of a first PVC pipe and which has a plurality of chains extending therefrom; and a second member comprising a bull-plate which secures to the open end of a second PVC pipe and which has at least two chains extending therefrom; and a lever mechanism to join the two ends together such that when the lever is turned in a first direction, the pipes are thrust together tightly.

In a further embodiment, the invention comprises a system for joining two pipes comprising: a first horseshoe-shaped member which secures to the bell-end of a first pipe, said horseshoe-shaped member having a plurality of chains extending therefrom; a second member comprising a bull-plate which secures to the open end of a second pipe to be connected to the first pipe, said bull plate having at least two chains extending therefrom, and a lever mechanism configured to join the two ends together such that the lever affixes to each of the chains such that the chain of the horseshoe-shaped member is attached to a first side of the lever and the second bull-plate chain is attached to the second side of the lever, such that once said lever is thrust in a first direction, the chains tighten and the pipes are thrusted tightly together.

### DETAILED DESCRIPTION OF THE PRESENT INVENTION

The present invention is now described with reference to the enclosed figures wherein the same numbers are utilized where applicable. The present invention is specifically directed to a tool designed to put together twenty-foot sections of 8-inch, 10-inch, and 12-inch polyvinylchloride (PVC) pipes, including a leverage system. The present invention also may, in the alternative use a hydraulic cylinder. While the present invention is being described in the context of a connector of PVC pipe, other sizes of pipes can also be used. The teachings of the present invention are applicable to a wide variety of pipes.

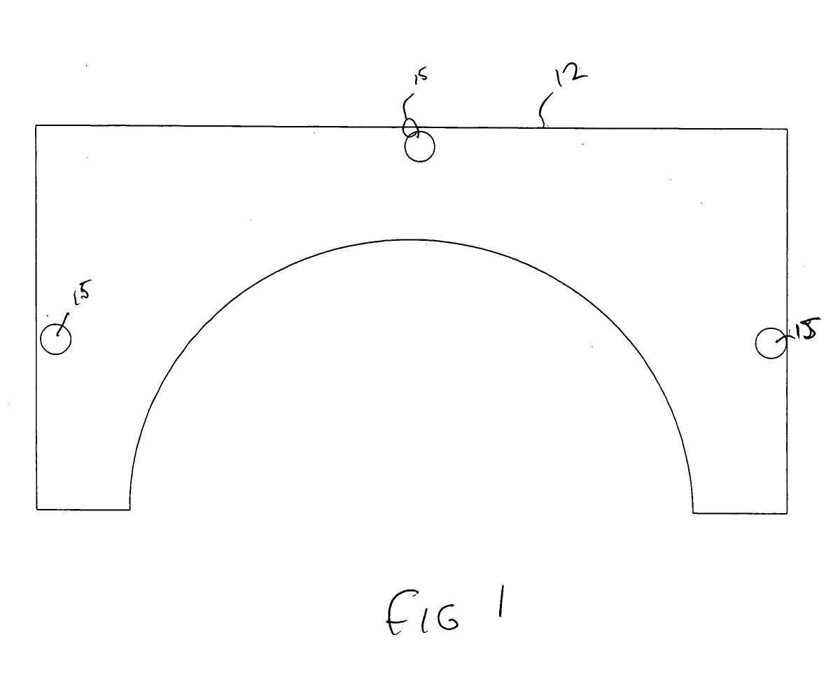

The invention specifically comprises three elements. Referring to the Figures, the first element is a horseshoe-shaped member 12 which fits around and collars the bell-end 14 of a first PVC pipe 16. The horseshoe-shaped member 12 has three chains 15 attached thereto which affix to each of the outer corners and center of the bell-end. As shown in the cross section view of FIG. 1a, the horseshoe-shaped member 12 has a semi-circular extension 19, 19a which assist in positioning the member 12.

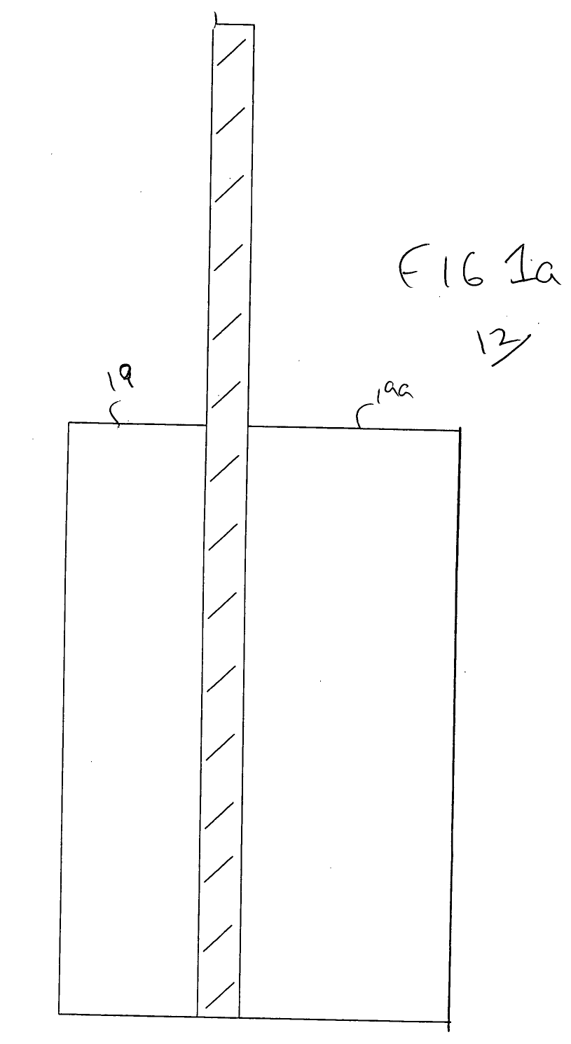

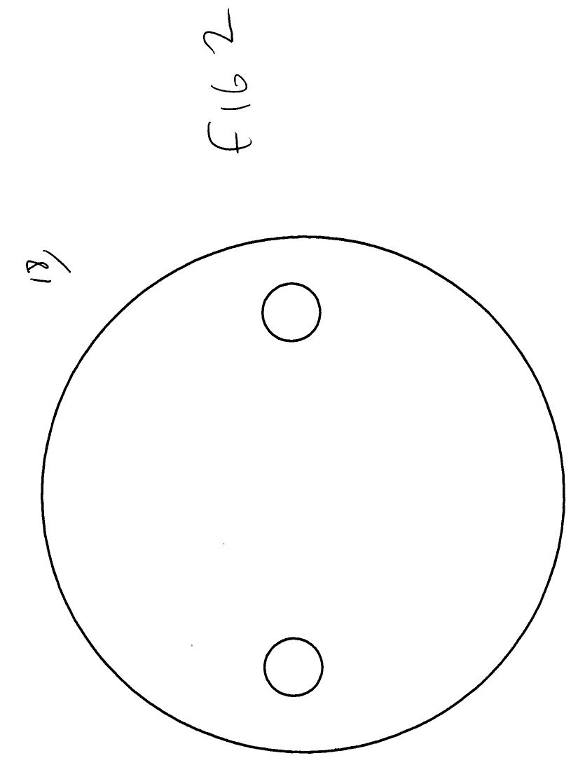

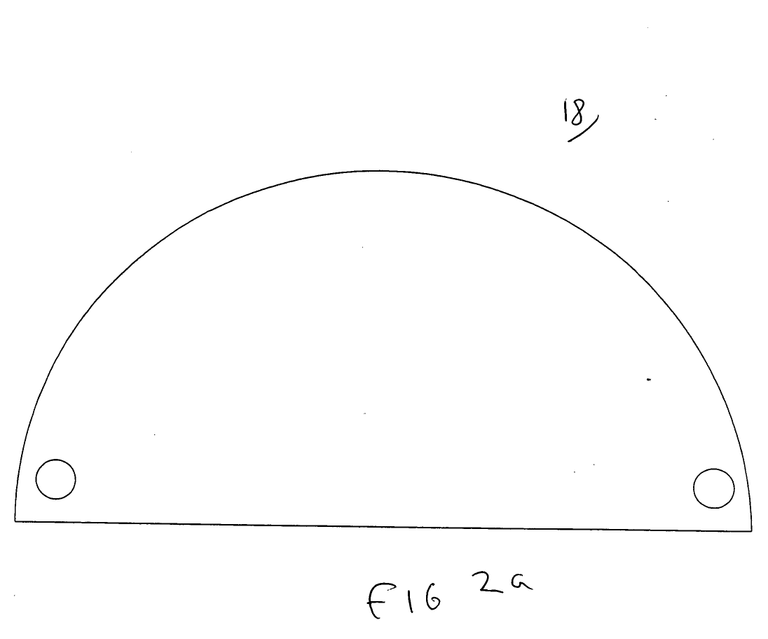

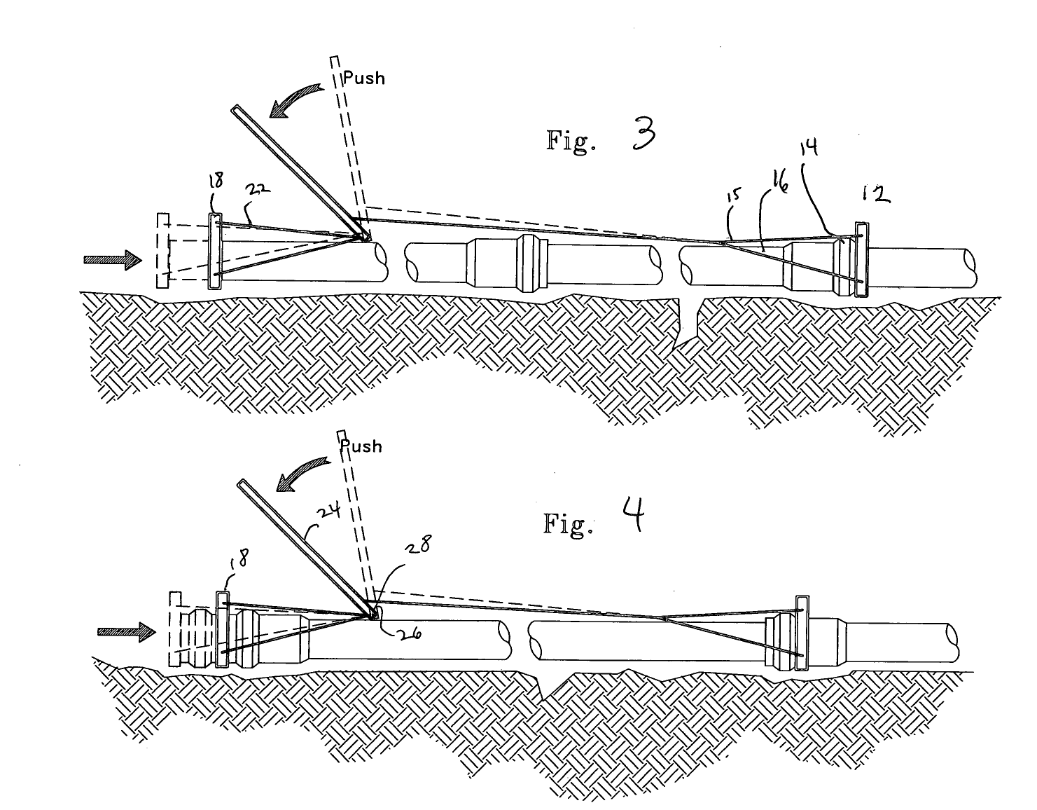

The second member 16 comprises a bull-plate 18 which fits the open end of a second PVC pipe 20 to be connected with the first pipe. This bull-end plate has two chains 22 extending therefrom from each of its sides. The bull-end plate 18 is preferably circular or semi-circular as shown in FIGS. 2 and 2a.

A lever mechanism 24 is configured to join the two ends. The lever is affixed by a brace 26 to a central position between the pipe ends and centrally located relative to the bull and horseshoe plates such that the chains of both members are affixed to opposite sides of the lever's fulcrum 28. Thus, when the lever is pulled in a first direction, positive tension is applied to both ends, such that the pipes are thrust together tightly. The process is then quickly repeated with the bell-end of the second pipe, forming the first part of a new coupling. Instead of a manual lever, the pipes could be connected via a hydraulic or pneumatic mechanism.

It is to appreciated that the present invention can be used to combine more than two pipes simultaneously. The present invention has been described with reference to the enclosed figures wherein the same numbers are utilized. It is to be appreciated that the true nature and scope of the present invention is to be determined with respect to the claims appended hereto.

1. A system for joining two pipe sections together comprising:
a first horseshoe-shaped member which fits around and collars the bell end of a first PVC pipe and has tension chains extending therefrom;
a second member comprising a bull-plate which secures to the open end of a second PVD pipe and has second tension chains extending therefrom;
a lever mechanism to join the two chains together such that when the lever is turned in a first direction, the pipes are thrusted together tightly.

2. A system for joining two pipes comprising:
a first PVC pipe having a bell-end;
a first horsehoe-shaped member which secures to said bell-end of said first PVC pipe, said horseshoe-shaped member having a plurality of chains extending therefrom, said plurality of chains being attached substantially radially opposite;
a second PVC pipe having an open end;
a second member comprising a bull-plate which secures to said open end of said second PVC pipe to be connected to said first PVC pipe, said bull plate having at least two chains extending therefrom, said at least two chains being attached substantially radially opposite;
a lever mechanism configured to join said first PVC pipe and said second PVC pipe together such that said lever mechanism affixes to said plurality of chains and said at least two chains such that said plurality of chains are attached to a first side of said lever mechanism and said at least two chains are attached to a second side of said lever mechanism, such that once said lever mechanism is thrust in a first direction, said first PVC pipe and said second PVC pipe are trussed tightly together with an axially directed force.

3. The apparatus of claim 2 wherein said first PVC pipe has a diameter in the range of eight inches to twelve inches.
